(19) United States
(12) Patent Application Publication
(10) Pub. No.: US 2012/0305671 A1
(43) Pub. Date: Dec. 6, 2012

(54) SPRAYER FOR A HOSE

(75) Inventor: Chin-Yuan Chen, LU-KANG TOWN (TW)

(73) Assignee: SHIN TAI SPURT WATER OF THE GARDEN TOOLS CO., LTD., LU-KANG TOWN (TW)

(21) Appl. No.: 13/151,275

(22) Filed: Jun. 2, 2011

(51) Int. Cl. B05B 7/12; B05B 1/12

(52) U.S. Cl. 239/526

(57) ABSTRACT

A sprayer for a hose includes: a handle portion, a tube portion and a water control valve set. The handle portion and the tube portion are two individual metallic members. The handle portion and the tube portion are assembled together, and the water control valve set is disposed in the handle portion. Moreover, the handle portion is placed into a mold to form a grip cover around the handle portion covering the connecting tube and the connecting member to combine together the handle portion and the tube portion.

### BACKGROUND OF THE INVENTION

1. Field of the Invention

The present invention relates to a sprayer for a hose, and more particularly to a sprayer having a grip cover only around the handle portion.

2. Description of the Related Art

An important job for gardening is watering the plants, which requires a hose to bring the water and to cover a large area. However, hoses can only provide a single strong water stream; by attaching a sprayer to the hose one can change the water stream into a mist for a better watering effect.

Most typical sprayers are made by casting and usually comprise a handle portion and a tube portion as a whole unit. However, the manufacturing process for the handle portion and the tube portion is complicated and difficult which often results in lower yields.

Therefore, it is desirable to provide a sprayer for a hose to mitigate and/or obviate the aforementioned problems.

### SUMMARY OF THE INVENTION

An objective of the present invention is to provide a sprayer for a hose.

In order to achieve the above-mentioned objectives, a sprayer for a hose includes: a handle portion, a tube portion and a water control valve set. The handle portion and the tube portion are two individual metal members. The handle portion has a first channel, an end of the first channel connected to a second channel, and a second channel upwardly extends out from a connecting joint positioned on a top end of the handle portion. The connecting joint is jacked with a sealing ring. A rear portion of the handle portion includes a space disposed between the first channel and the second channel. A through aperture is disposed in front of the space, and a side other than the connecting joint of the top end of the handle portion has a fixture base. The tube portion is horizontally disposed and has an enlarged opening at a front end. The enlarged opening is connected to a third channel, and a connecting tube connected to the third channel and a connecting member are disposed below the tube portion. The water control valve set has a control rod, a spring and a cover. The control rod and the spring are disposed into the space via a rear end of the handle portion. The spring protrudes from the through aperture, and the enlarged plug of the control rod is used for controlling water flow. When the water control valve set is assembled, the connecting joint of the handle portion is inserted into the connecting tube of the tube portion, the fixture base and the connecting member are positioned via an assembling element, and the handle portion is placed into a mold to form a grip cover around the handle portion covering the connecting tube and the connecting member to combine together the handle portion and the tube portion.

The above-mentioned sprayer has the following benefits: 1. After the handle portion and the tube portion are assembled together, the grip cover is formed to finish the sprayer; therefore, the sprayer has reduced manufacturing difficulties and costs. 2. The grip cover only covers the handle portion, while the tube portion made of metal is visible, which can provide a different visual effect for the sprayer.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a sprayer according to an embodiment of the present invention.

FIG. 2 is a transparent perspective view of the sprayer according to an embodiment of the present invention.

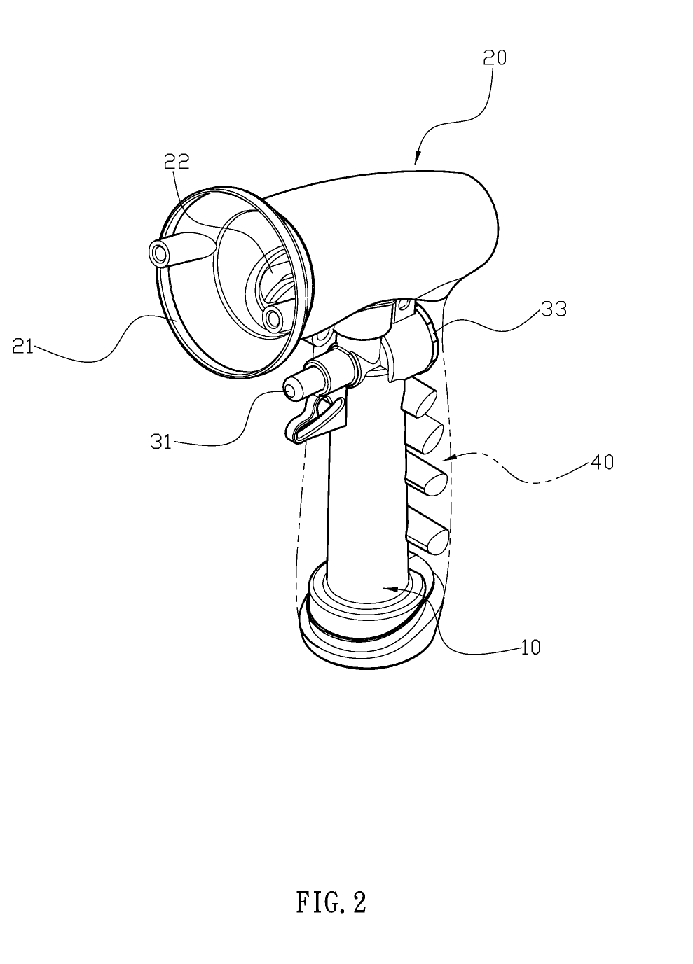

FIG. 3 is an exploded view of the sprayer according to an embodiment of the present invention.

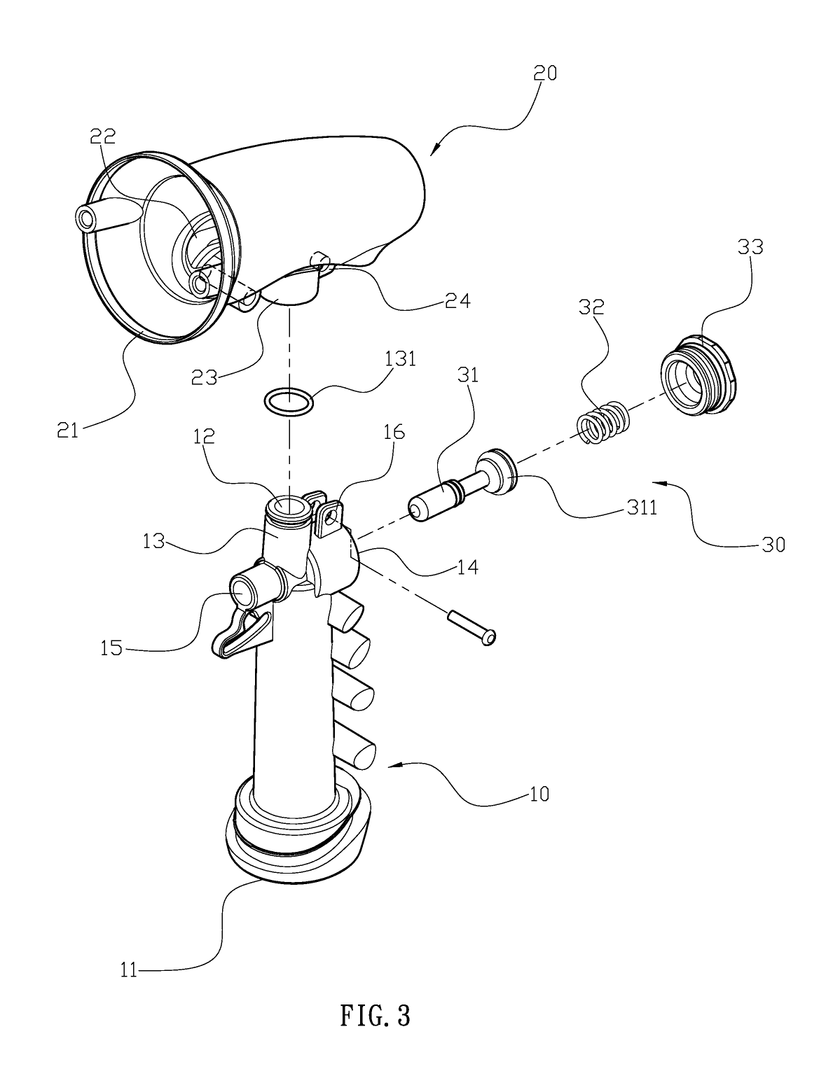

FIG. 4 shows the sprayer being covered with a grip cover according to an embodiment of the present invention.

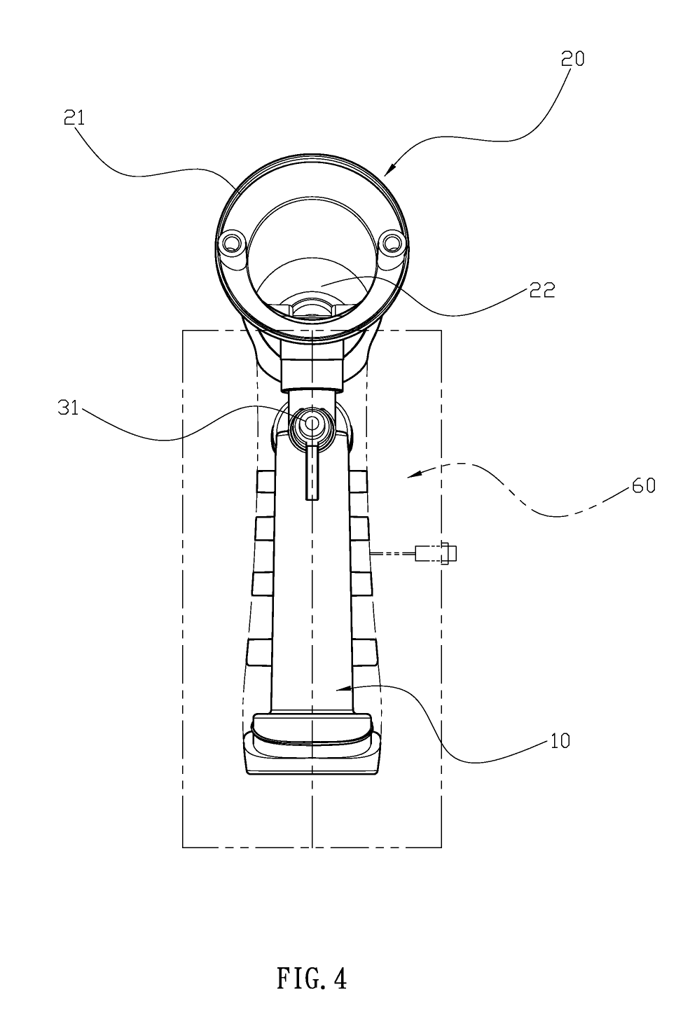

FIG. 5 is a cross-sectional view of the sprayer according to an embodiment of the present invention.

FIG. 6 is a perspective view of the sprayer having according to an embodiment of the present invention.

FIG. 7 is a cross-sectional drawing of the sprayer having according to an embodiment of the present invention.

### DETAILED DESCRIPTION OF THE PREFERRED EMBODIMENT

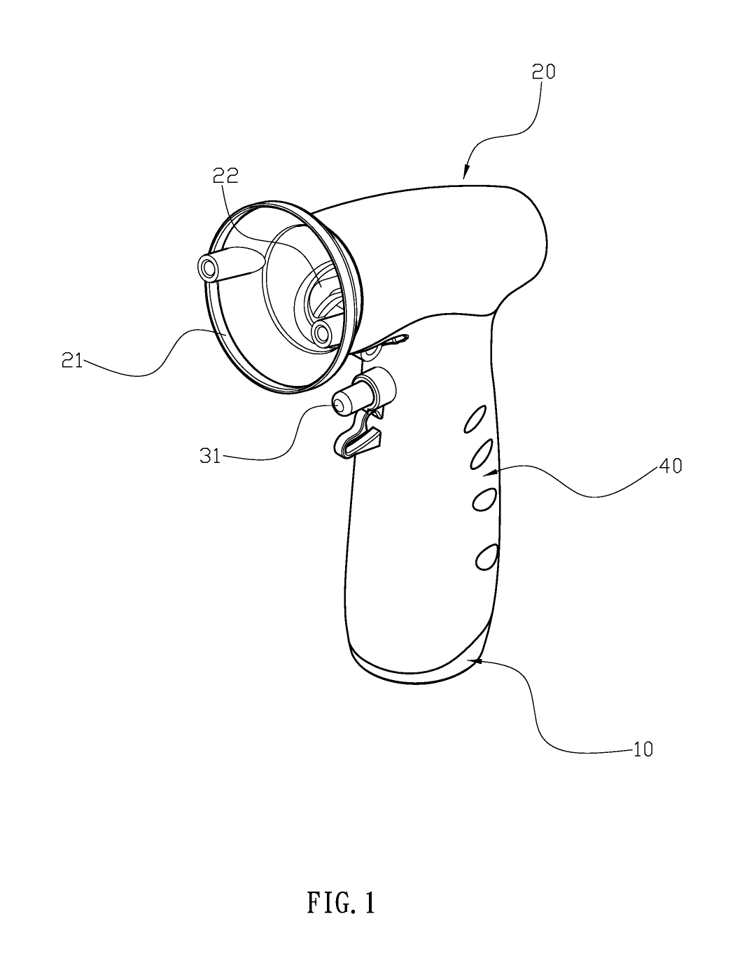

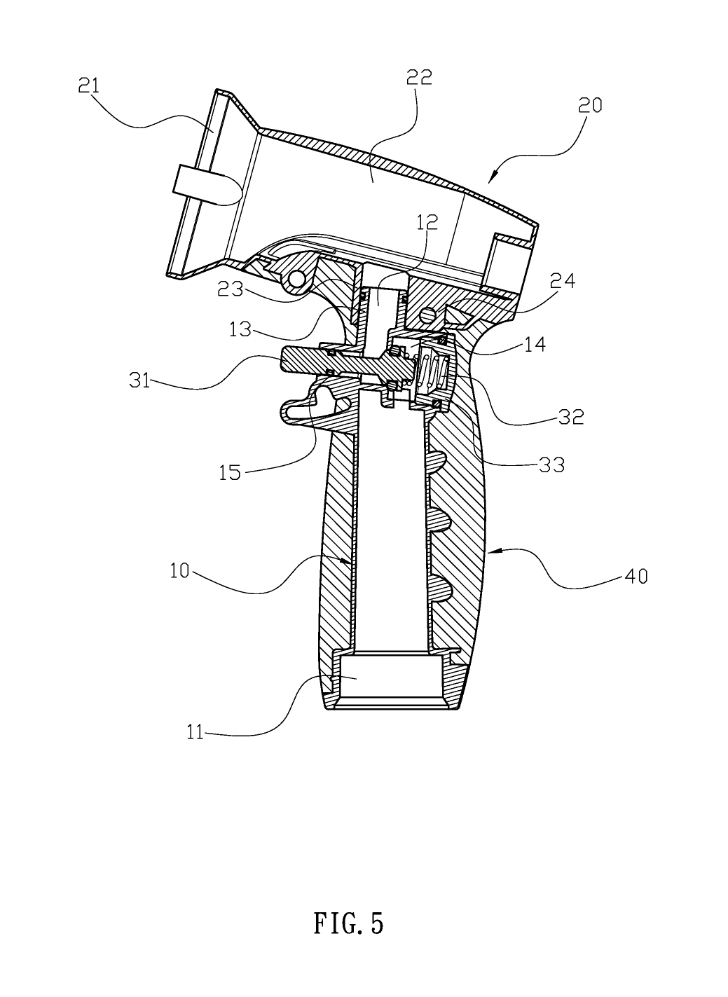

Please refer to FIG. 1 and FIG. 5. The sprayer comprises a handle portion 10, a tube portion 20 and a water control valve set 30. The handle portion 10 and the tube portion 20 are two individual metal members. The handle portion 10 has a first channel 11, an end of the first channel 11 connected to a second channel 12, with the second channel 12 upwardly extending out from a connecting joint 13 positioned on a top end of the handle portion 10. The connecting joint 13 is jacketed with a sealing ring 131. A rear portion of the handle portion 10 includes a space 14 disposed between the first channel 11 and the second channel 12. A through aperture 15 is disposed in front of the space 14, and a side other than the connecting joint 13 of the top end of the handle portion 10 has a fixture base 16. The tube portion 20 is horizontally disposed and has an enlarged opening 21 at a front end. The enlarged opening 21 is connected to a third channel 22, and a connecting tube 23 connected to the third channel 22 and a connecting member 24 are disposed below the tube portion 20. The water control valve set 30 has a control rod 31, a spring 32 and a cover 33. The control rod 31 and the spring 32 are disposed into the space 14 via a rear end of the handle portion 10. The spring 32 protrudes from the through aperture 15, and the enlarged plug 311 of the control rod 31 is used for controlling water flow. When the water control valve set 30 is assembled, the connecting joint 13 of the handle portion 10 is inserted into the connecting tube 23 of the tube portion 20, and the fixture base 16 and the connecting member 24 are positioned via an assembling element, such as a rivet. Moreover, the handle portion 10 is placed into a mold 60 to form a grip cover 40 around the handle portion 10 covering the connecting tube 23 and the connecting member 24 to combine together the handle portion 10 and the tube portion 20.

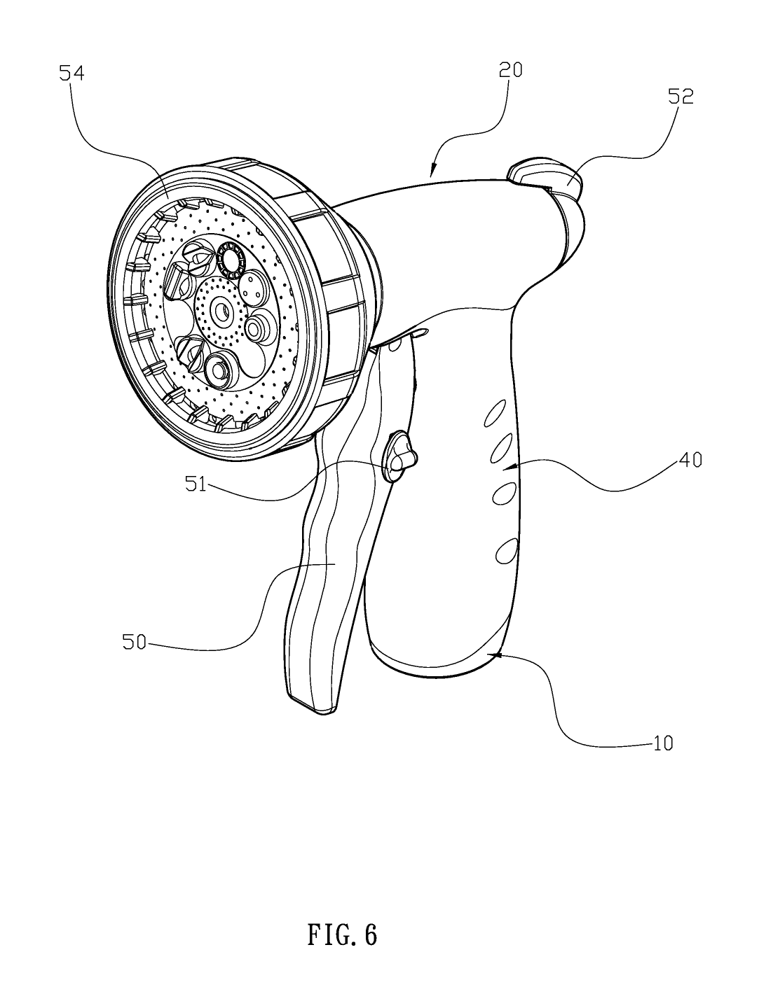

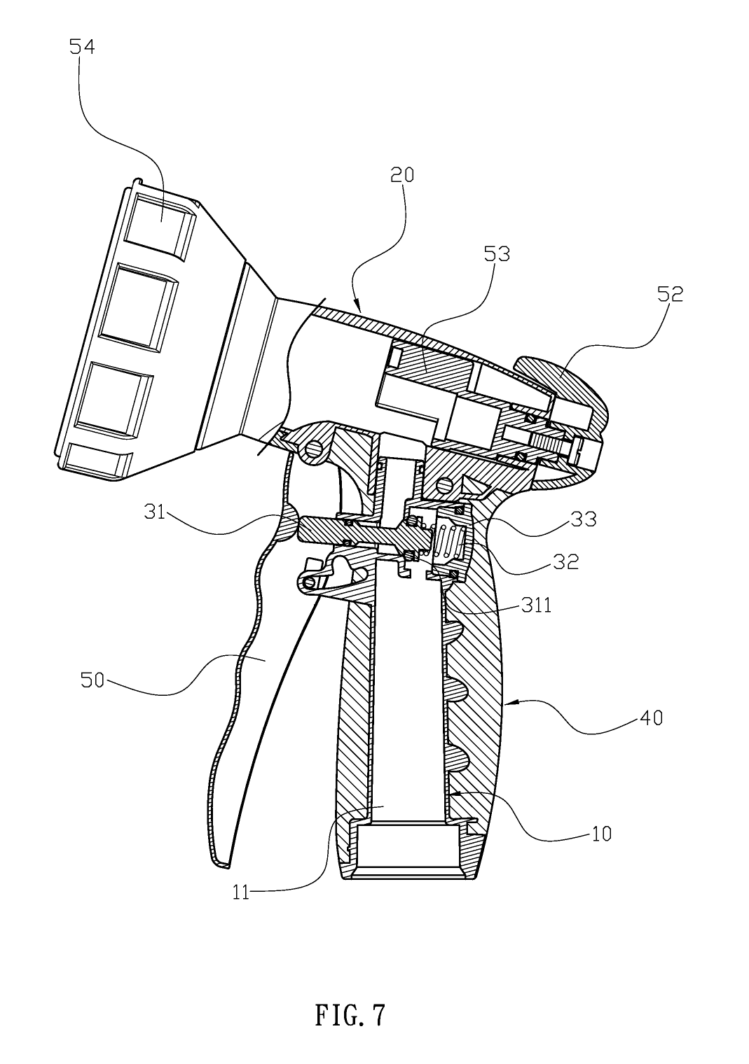

In use, the sprayer comprises a pressing handle 50, a lock 51, an adjusting member 52, a control shaft 53 and a head portion 54, as shown in FIG. 6 and FIG. 7. When the pressing handle 50 is pressed, the control rod 31 is pushed inwardly to move the plug 311 backwards without blocking the second channel 12. Water input from the first channel 11 passes through the second channel 12 and the third channel 22 to be sprayed from the head portion 54. When the pressing handle 50 is pressed down completely, the user can push up the lock 51 to secure the pressing handle 50 and the control rod 31, such that the water flow is continuous without the user needing to maintain pressure on the pressing handle 50. While the pressing handle 50 is fixed, the user can use the adjusting member 52 to rotate the control shaft 53 to change the flow.

The above-mentioned sprayer has the following benefits: 1. After the handle portion 10 and the tube portion 20 are assembled together, the grip cover 40 is formed to finish the sprayer; therefore, the sprayer has reduced manufacturing difficulties and costs. 2. The grip cover 40 only covers the handle portion 10, while the tube portion 20 made of metal is visible, which can provide a different visual effect for the sprayer.

Although the present invention has been explained in relation to its preferred embodiment, it is to be understood that many other possible modifications and variations can be made without departing from the spirit and scope of the invention as hereinafter claimed.

What is claimed is:

1. A sprayer for a hose comprising: a handle portion, a tube portion and a water control valve set, wherein
the handle portion and the tube portion are two individual metal members, the handle portion has a first channel, one end of the first channel connected to a second channel, and the second channel upwardly extends out from a connecting joint positioned on a top end of the handle portion, the connecting joint jacked with a sealing ring, a rear portion of the handle portion including a space disposed between the first channel and the second channel, a through aperture disposed in front of the space, and a side other than the connecting joint of the top end of the handle portion has a fixture base;
the tube portion is horizontally disposed and has an enlarged opening at a front end, the enlarged opening connected to a third channel, and a connecting tube connected to the third channel and a connecting member are disposed below the tube portion;
the water control valve set has a control rod, a spring and a cover, the control rod and the spring disposed into the space via a rear end of the handle portion, the spring protruding from the through aperture, and the enlarged plug of the control rod used for controlling water flow;
wherein when the water control valve set is assembled, the connecting joint of the handle portion is inserted into the connecting tube of the tube portion, the fixture base and the connecting member are positioned via an assembling element, the handle portion is placed into a mold to form a grip cover around the handle portion covering the connecting tube and the connecting member to combine together the handle portion and the tube portion.

2. The sprayer for a hose as claimed in claim 1, wherein the fixture base comprises two separated sheet members.

3. The sprayer for a hose as claimed in claim 1, wherein the sprayer head further comprises a pressing handle, a lock, an adjusting member, a control shaft and a head portion.
